(19) United States
(12) Patent Application Publication
(10) Pub. No.: US 2006/0013166 A1
(43) Pub. Date: Jan. 19, 2006

(54) Method for determining the distance between a first and second transmitting and receiving station

(76) Inventors: Heinrich Haas, Meckenbeuren (DE); Thomas Oexle, Markdorf (DE); Rolf Schuler, Salem (DE); Wolfgang Schulter, Meersburg (DE); Udo Knepper, Langenargen (DE)

Correspondence Address: FASSE PATENT ATTORNEYS, P.A., P.O. BOX 726, HAMPDEN, ME, 04444-0726, US

(21) Appl. No.: 10/530,913

(22) PCT Filed: Sep. 8, 2003
(86) PCT No.: PCT/DE03/02967

§ 371 Date: Apr. 8, 2005

(30) Foreign Application Priority Data
Oct. 12, 2002 (DE) 10247718.3

(51) Int. Cl. H04Q 7/00

(52) U.S. Cl. 370/332; 370/343

(57) ABSTRACT

In automotive engineering transmitting and receiving stations are usually used in keyless locking systems as electronic key modules or evaluation units for identifying the key module. Deactivation of the locking system is prevented if the key module allocated by means of a clear identification number from the evaluation unit is not in the immediate vicinity of the evaluation unit. The novel method shall determine the distance between two transmitting and receiving stations with high resolution.

According to the novel method, a transmission signal (S1, S2) respectively is generated in the transmitting and receiving stations (1, 2) and transmitted as a series of microwave pulses having a predefined pulse repetition frequency (fp1, fp2) to the other respective transmitting and receiving station (2, 1) and received thereby in the form of a received signal. The pulse repetition frequencies (fp1, fp2) of the transmission signals (S1, S2) vary according to a predefined differential frequency value (fd), which is preferably small in relation to the impulse repetition frequencies. Points of coincidence (t11, t12, . . . ; t21, t22) are determined in the transmitting and receiving stations (1, 2), corresponding to those moments in time, when the pulses of the transmission signal (S1, S2) sent by the respective transmitting and receiving station (1, 2) and the received signal E1, E2) received by the respective transmitting and receiving station (1, 2) coincide. The distance between the transmitting and receiving stations is then determined from the distance between the points of coincidence.

The invention relates to a method for determining the distance between a first and second transmitting and receiving station according to the preamble of patent claim 1.

A method of this type is known for example from DE 100 19 277 A1. In this method a radio link is established for transmitting data between an electronic key module to be carried by and on the user and an evaluation unit provided in a motor vehicle, in order to identify the key module based on an identification number stored in the key module, and to release, if necessary, the motor vehicle for use. The radio link is established here via a transmitting and receiving station provided in the key module and in the evaluation unit. To prevent the radio link from being extended via relay stations and to release the motor vehicle in this way without being noticed by the authorized user, the distance between the key module and the evaluation unit is determined and the release of the motor vehicle is prevented, if the key module is not within the immediate vicinity of the evaluation unit. In this case, determination of the distance is based on an evaluation of the signal running time of the signals transmitted via the radio link.

It is the object of the invention to indicate a method for determining the distance between two transmitting and receiving stations, which can be implemented at low expenditure and which enables measurement of short distances with high resolution.

The object is achieved by the features of patent claim 1. Advantageous developments and further embodiments of the invention become apparent from the further claims.

In accordance with the invention the distance between a first and second transmitting and receiving station is determined by measuring the signal running time of a first transmission signal generated in the first transmitting and receiving station and transmitted to the second transmitting and receiving station and of a second transmission signal generated in the second transmitting and receiving station and transmitted to the first transmitting and receiving station. The first transmitting and receiving station receives the second transmission signal transmitted from the second transmitting and receiving station as a first received signal and the second transmitting and receiving station receives the first transmission signal transmitted from the first transmitting and receiving station as a second received signal. The transmission signals are respectively generated as a series of microwave pulses having a predefined pulse repetition frequency, which frequencies vary according to a predefined differential frequency value which is preferably small in relation to the impulse repetition frequencies. Furthermore, in the first transmitting and receiving station first points of coincidence are determined and in the second transmitting and receiving station second points of coincidence are determined, the first points of coincidence corresponding to those moments in time, when the pulses of the first transmission signal and the pulses of the first received signal received by the first transmitting and receiving station coincide. The signal running time of the transmission signals and thus also the distance between the transmitting and receiving stations is then determined from the distances between the points of coincidence.

In a preferred embodiment of the method a distance of coincidence, which represents the time offset between the first and the second points of coincidence, is determined as a measure of the signal running time of the transmission signals and thus as a measure of the distance between the two transmitting and receiving stations.

Preferably, for this purpose information is transmitted via the second points of coincidence via a radio channel from the second transmitting and receiving station to the first transmitting and receiving station. The distance of coincidence is then determined in the first transmitting and receiving station from the transferred information and from the first points of coincidence determined in the first transmitting and receiving station. The transmission of the information on the second points of coincidence and the transmission of the transmission signals is performed preferably via different radio channels.

In a further preferred embodiment of the method the second transmission signal is modulated by frequency keying of its pulse repetition frequency and a change, resulting from frequency keying, of the distance between the first points of coincidence is determined as a measure of the distance between the transmitting and receiving stations. Here, the pulse repetition frequency of the second transmission signal is preferably changed between two fixed frequency values with chronological synchronism to the second points of coincidence.

The two fixed frequency values are advantageously specified such that the change from one frequency value to the other frequency value causes duplication of the amount of the difference between the pulse repeat frequencies of the transmission signals or a reverse counting of this difference.

In an advantageous further development of the method data is transmitted from the second transmitting and receiving station to the first transmitting and receiving station by modulation of the second transmission signal. Advantageously, also the first transmission signal is modulated by frequency keying, in order to transmit data from the first transmitting and receiving station to the second transmitting and receiving station.

Preferably, for determining the points of coincidence in each transmitting and receiving station the transmission signal generated in the respective transmitting and receiving station is converted with the transmission signal received by this station by mixing into an intermediate frequency signal and by subsequent filtering and envelope demodulation into a pulsed evaluation signal. The pulses of the evaluation signals appear at the searched points of coincidence.

The method according to the invention is particularly suitable for use in a keyless locking system for motor vehicles. With a locking system of this type a base station is provided in the motor vehicle as an evaluation unit, which communicates with portable key modules via a radio link. The radio link is established via transmitting and receiving stations, which are provided in the base station and in the key modules. The radio link can be established without being noticed by the user for example by operating a door handle. Data is exchanged via the radio link, in particular identification numbers—advantageously in coded form—saved in the key modules are transmitted to the base station. The base station permits to gain access to the motor vehicle, if it recognizes on the basis of the identification number of a key module that an authorization to gain access is allocated to this key module, and if the key module is with in a certain distance to the base station. This distance is determined in accordance to the method according to the invention. Based on the high resolution it is furthermore possible to ascertain whether the key module is inside or outside the motor vehicle. Therefore, locking of the motor vehicle can be prevented, if the key module is inside the motor vehicle.

By taking into consideration the distance between the base station and the key module, security of the locking system is enhanced, since access to the motor vehicle is prevented also with a correct identification number, if the distance between the key module and the base station exceeds a certain value. Thus, unauthorized persons are not able to obtain access to the motor vehicle without being noticed by the authorized user, by establishing via relay stations a radio link between the key module and the base station.

Hereinafter the invention is further explained by the examples of embodiment taken in conjunction with the drawings.

FIG: 1 shows a block diagram with two transmitting and receiving stations for carrying out the method according to the invention,

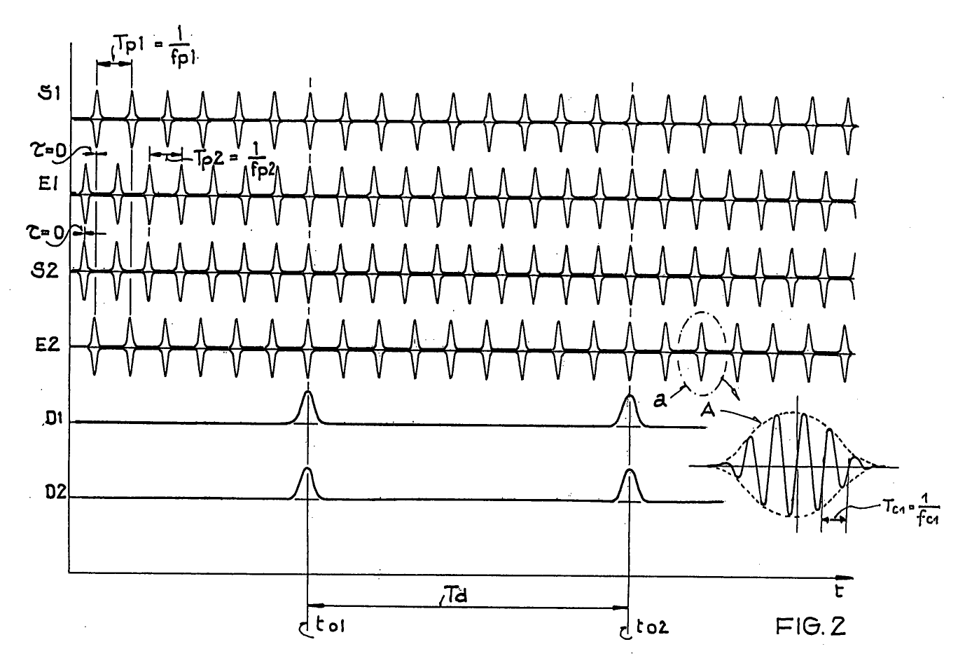

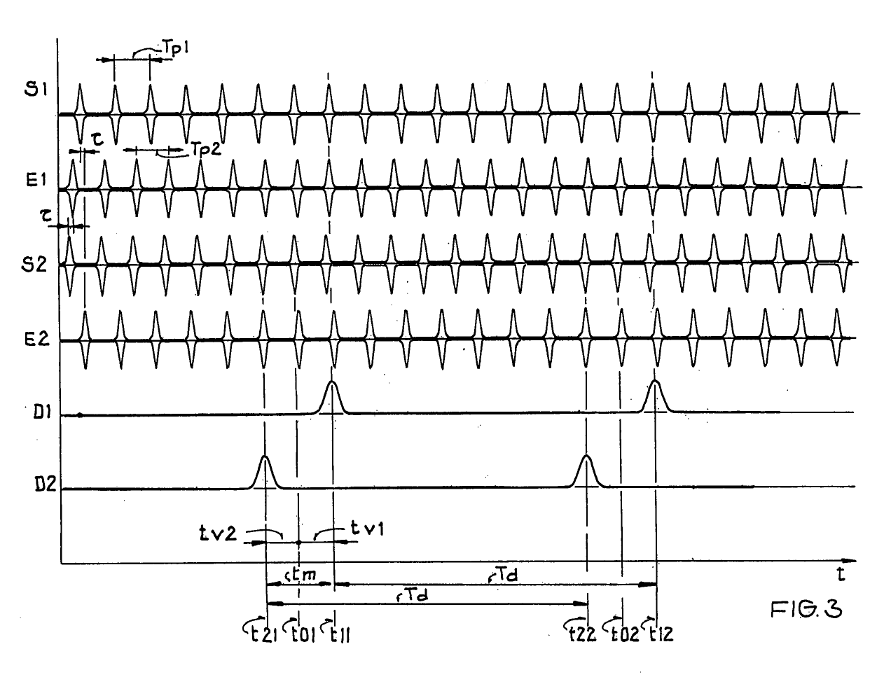

FIG. 2 show timing diagrams of the signals generated and processed in the transmitting and receiving stations.

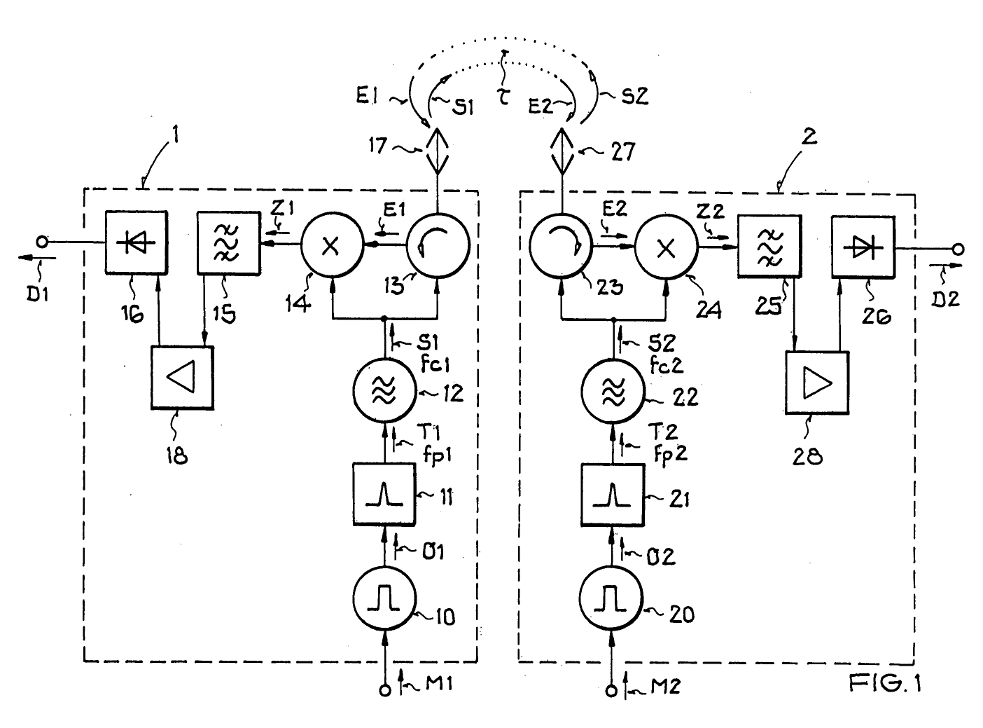

In accordance with FIG. 1 the first transmitting and receiving station 1 and the second transmitting and receiving station 2 are identically embodied. The first transmitting and receiving station 1 comprises a highly stable oscillator 10 with frequency modulation capability, a chopper 11, a microwave oscillator 12, a coupler 13, a mixer 14, an IF-filter 15, an IF-amplifier 18, an envelope demodulator 16 and a transmitting and receiving antenna 17. Accordingly, the second transmitting and receiving station 2 also comprises a highly stable oscillator 20 with frequency modulation capability, a chopper 21, a microwave oscillator 22, a coupler 23, a mixer 24, an IF-filter 25, an IF-amplifier 28, an envelope demodulator 26 and a transmitting and receiving antenna 27.

The transmitting and receiving stations 1 and 2 are activated by an alarm process and operate simultaneously.

In this connection the oscillator 10 with modulation capability generates in the first transmitting and receiving station 1 an oscillator signal O1, which can be modulated in frequency, as an indicator of a control signal M1, which signal O1 is supplied to the chopper 11, which generates out of it a trigger signal T1 with small impulses, which pulse distance or pulse repetition frequency fp1 is determined by the oscillation frequency of the oscillator signal O1. The trigger signal T1 is supplied to the microwave oscillator 12, which in response to the impulses of the trigger signal T1 generates a microwave pulse with several periods of the carrier frequency fc1 of the oscillator 12. The microwave oscillator 12 thus releases a series of microwave pulses as a first transmission signal S1, which is supplied via the coupler 13 to the transmitting and receiving antenna 17 and to the mixer 14.

Analogously, the oscillator 20 with modulation capability also generates in the second transmitting and receiving station 2 an oscillator signal O2, which can be modulated in frequency, as an indicator of a control signal M2, which signal O2 is supplied to the chopper 21, which also generates out of it a trigger signal T2 with small impulses, which pulse repetition frequency fp2 is determined by the oscillation frequency of the oscillator signal O2. The trigger signal T2 is supplied to the microwave oscillator 22, which in response to the impulses of the trigger signal T2 generates a microwave pulse with several periods of the carrier frequency fc2 of the oscillator 22. The microwave oscillator 22 thus releases a series of microwave pulses as a second transmission signal S2, which is supplied via the coupler 23 to the transmitting and receiving antenna 27 and to the mixer 24.

Then, via the transmitting and receiving antennas 17 and 27 the first and second transmission signal S1 and S2 are transmitted to the second and first transmitting and receiving station 2 and 1 and are received there as second and first received signal E2 and E1 via their transmitting and receiving antennas 27 and 17 after a time lag of a signal running time τ.

In the first transmitting and receiving station 1 the first received signal E1 is brought together in the mixer 14 with the first transmission signal S1 to an intermediate frequency signal Z1, from which by filtering in the IF-filter 15, amplification in the IF-amplifier 18 and subsequent demodulation in the envelope demodulator 16 a first evaluation signal D1 is generated. Accordingly, in the second transmitting and receiving station 2 the second received signal E2 is brought together in the mixer 24 with the second transmission signal S2 to an intermediate frequency signal Z2, from which by filtering in the IF-filter 25, amplification in the IF-amplifier 28 and subsequent demodulation in the envelope demodulator 26 a second evaluation signal D2 is generated.

The signal running time τ is the time the transmission signals S1, S2 require to get from one transmitting and receiving station to the other one. Based on the fixed propagation speed of electromagnetic waves it is a measure for the searched distance between the two transmitting and receiving stations 1, 2.

The carrier frequencies fc1, fc2 of the transmission signals S1, S2 are identical and are, for example, in the range of several GHz. However, for the said carrier frequencies it is not much demanded with regard to their accuracy and frequency stability.

The width of the impulses of the trigger signals T1, T2, is in the range of approx. 1 ns and the pulse repetition frequencies fp1, fp2 of the transmission signals S1, S2 are in the range of, for example, several MHz. It is substantial that the pulse repetition frequencies fp1, fp2 vary by a differential frequency value fd. Here, the accuracy of the distance measurement depends from the accuracy and frequency stability of the pulse repetition frequencies fp1, fp2.

FIG. 2 shows the diagrams of the transmission signals S1, S2 transmitted from the transmitting and receiving stations 1, 2, of the received signals E1, E2 received by the transmitting and receiving station 1, 2, of the intermediate frequency signals Z1, Z2, and of the evaluation signals D1, D2 for the case that the transmitting and receiving stations 1, 2 are at the same place. Thus, for the signal running time τ it applies that τ=0, i.e. the transmission signals S1, S2 are not delayed on the transmission path. Therefore, the first transmission signal S1 corresponds to the second received signal E2 and the second transmission signal S2 corresponds to the first received signal E1.

As is implicated in the enlarged view A of section a, merely the envelopes of the signals S1, S2, E1, E2 are depicted in the figure. These are impulses, which in the case of the first transmission signal S1 and the second received signal E2 are distanced from each other by a pulse period Tp1 and in the case of the second transmission signal S2 and the first received signal E1 are distanced from each other by a pulse period Tp2. The pulse periods Tp1, Tp2 correspond to the reciprocal value of the pulse repetition frequencies fp1 and fp2 of the respective signal.

The mixture in the mixers 14, 15 corresponds to a scanning of the first and second received signal E1 and E2 with the first and second transmission signal S1 and S2. The differential frequency value fd is chosen to be such small that this is a sub-scanning.

The resulting evaluation signals D1, D2 are also pulsed signals, which impulses appear periodically in the pulse distance Td. For the pulse distance Td it applies that Td=1/fd, fd representing the differential frequency value, by which the pulse repetition frequencies fp1, fp2 vary. The pulses of the first evaluation signal D1 appear at moments in time, at which pulses of the first transmission signal S1 and of the first received signal E1 coincide. Said moments in time are referred to hereinafter as first points of coincidence. Accordingly, the pulses of the second evaluation signal D2 appear at moments in time, at which pulses of the second transmission signal S2 and of the second received signal E2 coincide. These moments in time are referred to hereinafter as second points of coincidence.

In the figure also moments in time t01, t02 are shown, at which the pulses of the two transmission signals S1, S2 coincide in time. These moments in time, which are also distanced from each other by the pulse distance Td, are referred to hereinafter as transmission points of coincidence.

With a signal running time τ=0 the first and second points of coincidence coincide with the transmission points of coincidence, as the received signals E1, E2 coincide in time with the respective transmission signals S1 and S2.

FIG. 3 shows the signals from FIG. 2 for the case that the first received signal E1 in relation to the second transmission signal S2 and the second received signal E2 in relation to the first transmission signal S1 are time lagged on the transmission path by a signal running time τ>0. Then, the evaluation signals D1 and D2 are shifted in relation to the transmission points of coincidence t01, t02 each in different directions. The shifting direction here depends on the fact whether the first transmission signal S1 in relation to the second transmission signal S2 shows the higher or lower pulse repetition frequency. In the case shown the first evaluation signal D1 is shifted to the right in relation to the transmission points of coincidence t01, t02 by a first shifting value tv1, whereas the second evaluation signal D2 is shifted to the left by a second shifting value tv2. One then obtains the moments in time till, t12 as first points of coincidence and the moments in time t21, t22 as second points of coincidence. For the shifting values tv1, tv2 it applies
tv1=τ·na1
tv2=τ·na2
with

$$na1 = \frac{fp1}{fd} = \frac{fp1}{\vert fp1 - fp2 \vert}$$

$$na2 = \frac{fp2}{fd} = \frac{fp2}{\vert fp1 - fp2 \vert}$$

τ standing for the signal running time, fp1 and fp2 for the pulse repetition frequency of the first and second transmission signal S1 and S2 and fd for the differential frequency value. The sizes na1, na2 are referred to hereinafter as gauge factors.

The pulses from the evaluation signals D1, D2 are thus shifted against each other by a distance of coincidence tm=tv1+tv2 determined by the signal running time τ. If the differential frequency value fd is chosen to be small in relation to the pulse repetition frequencies fp1, fp2, the gauge factors na1, na2 are about the same size. For the distance of coincidence tm the following applies in approximation
tm=2τ·na
with
na=na1≈na2.

Based on the proportionality between the distance of coincidence tm and the signal running time τ, the signal running time τ and thus also the distance between the transmitting and receiving stations 1 and 2 can now be determined by measuring the distance of coincidence tm.

If the gauge factor na is chosen to be high, the measurement of the signal running time τ of the transmission signals S1, S2 from an original time domain can be traced back to a time basis which is higher by several sizes in relation to the signal running time τ in a represented time domain of the evaluation signals D1, D2. For instance, the measurement of times in the size of several ns in the original time domain can be traced back to a measurement of time in the size of several μs or even ms in the represented time domain, what is combined with low technical expenditure. Consequently, with a low expenditure distances with a local resolution of approx. 10 cm can be measured, what corresponds to a time resolution of about 300 ps in the original time domain.

If distance measurement is to be performed at the place of the first transmitting and receiving station 1, for determining the distance of coincidence tm at this place the first points of coincidence t11, t12 as well as the second points of coincidence t21, t22 are to be known or sizes are to be provided at the place of the first transmitting and receiving station 1, which are in a certain relationship with the points of coincidence t21, t22.

In a first example of embodiment information is transferred from the second transmitting and receiving station 2 to the first transmitting and receiving station 1 via the two points of coincidence t21, t22 via a separate radio channel, i.e. via a radio channel, which carrier frequency differs from the carrier frequency of the first and second transmission signal S1, S2. In this connection, the carrier frequency of the separate radio channel is advantageously smaller than the carrier frequency of the transmission signals S1, S2. From the first and second point of coincidence thus known at the place of the first transmitting and receiving station 1, the distance of coincidence tm and from this the signal running time τ or the distance between the transmitting and receiving stations 1 and 2 can be determined.

However, the signal running time τ can also be determined by modulating the second transmission signal S2 and by evaluating the change, resulting from the modulation, of the distance between the first points of coincidence t11, t12, . . . i.e. of the pulse distance between the pulses of the first evaluation signal D1, as explained in the following, or by modulating the first transmission signal S1 and by evaluating the change, resulting from the modulation, of the distance between the second points of coincidence t21, t22, . . . i.e. the pulse distance between the pulses of the second evaluation signal D2.

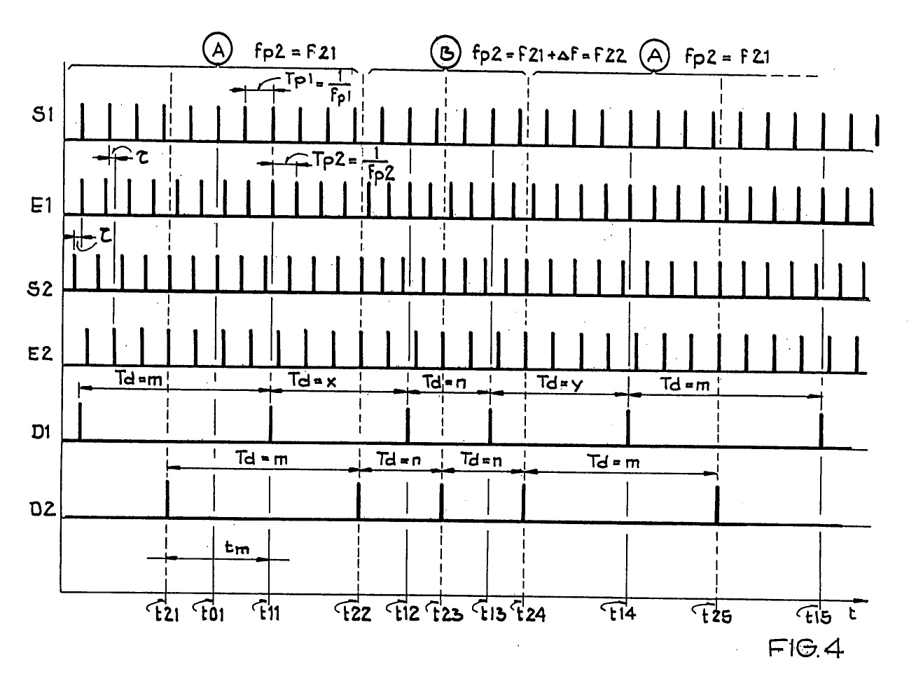

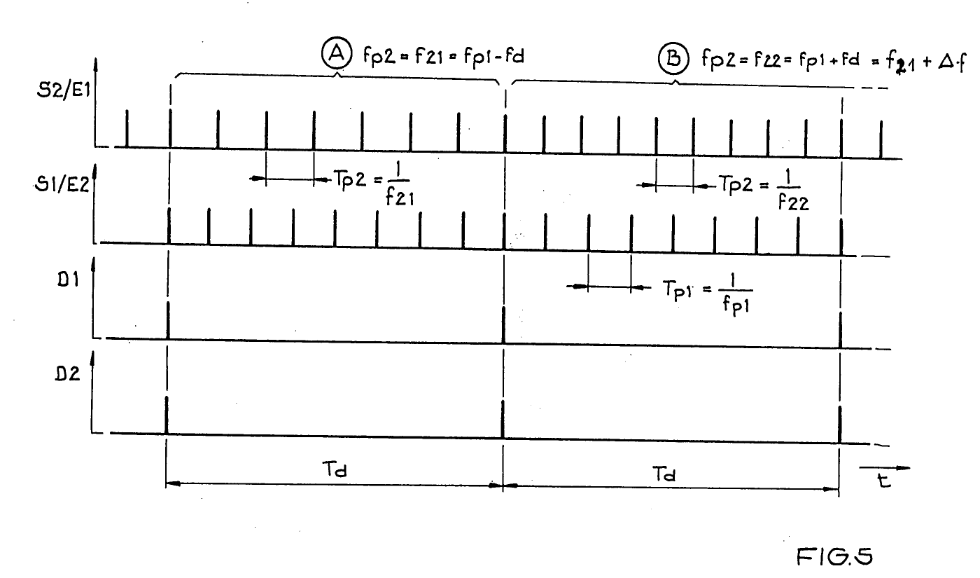

FIG. 4 shows the signals from FIGS. 2 and 3 for the case that the second transmission signal S2 is modulated by frequency keying of the pulse repetition frequency fp2. Now, the pulses of the signals are merely represented by lines, which mark the moments in time the pulses appear.

Starting from the case that for the differential frequency value fd it applies
fd=fp2−fp1 with fp2>fp1,
with frequency keying the pulse repetition frequency fp2 of the second transmission signal S2 surges from a first fixed frequency value f21 by a predefined frequency step Δf to a second fixed frequency value f22=f21+Δf, i.e. the differential frequency value fd is multiplied, or is reduced from the second frequency value f22 to the first frequency value f21. Frequency keying is performed here with chronological synchronism to the pulses of the second evaluation signal D2.

In the shown example the pulse repetition frequency fp2 is switched over to the points of coincidence t22, t24. In the time segments A the pulse repetition frequency fp2 is then equal to the first frequency value f21 and in the time segment B it is equal to the second frequency value f22. The consequence of the frequency jumping by the frequency step Δf is that the pulse distance Td between the pulses of the second evaluation signal D2 is reduced by frequency keying from value m to value n and in turn is increased from value n to value m. If the frequency step Δf—as in shown in the figure—is chosen to be equal to the value
Δf=f21−fp1=fd,
the amount of the differential frequency value
fd=|fp1−fp2|
is doubled when passing over from the time segment A into the time segment B and is halved again when passing from the time segment B into the next time segment A. Therefore, the value m is twice as high as the value n.

A further consequence of frequency keying is that with the up-keying of the pulse repetition frequency fp2 to the second fixed frequency value f22 the pulse distance Td between the pulses of the first evaluation signal D1 is reduced by a distance proportional time td from the value m to a value x. Accordingly with the back-keying of the pulse repetition frequency fp2 to the first fixed frequency value f21 and based on the increase of the pulse distance Td between the pulses of the second evaluation signal D2 of the pulse distance Td between the pulses of the first evaluation signal D1 is increased by the distance proportional time td from value n to a value y.

For the values x and y it applies

$$x = m - td$$

$$y = n + td , \\ with$$

$$td = τ \cdot na2 = τ \cdot \frac{f21}{f21 - fp1} = τ \cdot \frac{f21}{fd} .$$

Here, m and n stand for the long or short pulse distance Td between the pulses of the second evaluation signal D2, td for the distance proportional time, τ for the signal running time and na2 for the gauge factor with the pulse repetition frequency fp2=f21. The values x and y are thus linearly dependent from the signal running time τ.

The above equation is valid for high gauge factors na2 and for a frequency step of Δf=f21−fp1=fd. If the frequency step Δf is optionally chosen, it applies

$$td = 2 \cdot ( τ \cdot na2 - τ \cdot {na2}^{*} ) = 2 \cdot τ \cdot ( na2 - {na2}^{*} )$$

$$with$$

$$na2 = \frac{f21}{f21 - fp1}$$

$${na2}^{*} = \frac{f22}{f22 - fp1} = \frac{f21 + Δ f}{f21 + Δ f - fp1} .$$

Here, na2 and na2* stand for the gauge factors with the pulse repetition frequency fp2=f21 and fp2=f22=f21+Δf, respectively.

Consequently, by measuring the values x and y it is possible to determine the distance proportional time td and from it the signal running time τ as well as the distance between the transmitting and receiving stations 1 and 2.

Apart from determination of the signal running time τ the described method simultaneously permit also to transfer data from the second transmitting and receiving station 2 to the first transmitting and receiving station 1. For this purpose it is merely necessary to respectively allocate one of the logical values “0” or “1” to the values m and n. Then, the logical value of the value m is to be allocated to the value x and the logical value of the value n to the value y. In like manner by frequency keying also data can be transferred from the first transmitting and receiving station 1 to the second transmitting and receiving station 2.

Based on frequency keying at the outputs of the mixers 14, 24 two intermediate frequencies f=fc/na2, fi*=fc/na2* varying from each other are produced, fc standing for the carrier frequency of the transmission signals S1, S2, so that the IF-filters 15, 25 each must show two pass-bands.

This disadvantage is avoided by choosing the frequency step Δf such that frequency keying effects reverse counting of the difference between the pulse repetition frequencies fp1, fp2. The frequency values f21, f22 are to be chosen such that the pulse repetition frequency fp1 is in the middle of these values.

For a frequency keying of this type FIG. 5 shows the transmission signals S1, S2, the received signals E1, E2 and the evaluation signals D1, D2 for the case that the pulse repetition frequency fp2=fp21=fp1−fd is keyed to a value fp22=fp21+Δf=fp1+fd, i.e. with Δf=2·fd. Here the case is shown for a signal running time τ=0. In this case the frequency step Δf does not change the pulse distance Td between the pulses of the evaluation signals D1, D2.

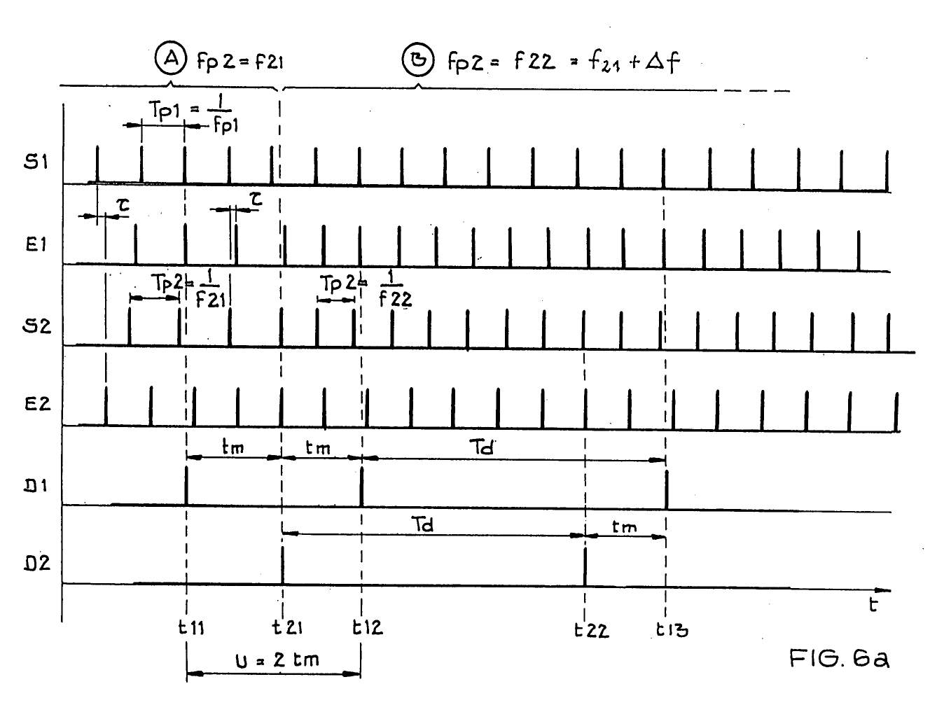

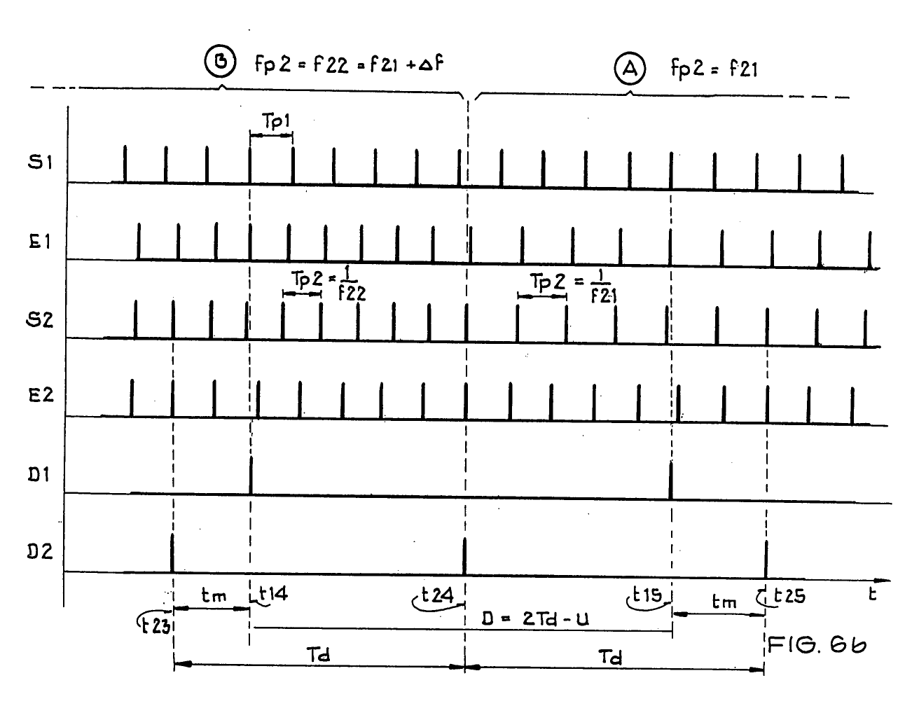

FIGS. 6a and 6b show equal signals for a signal running time τ>0. In the time segment A the pulse repetition frequency fp2 of the second transmission signal S2 is equal to the first frequency value f21 and in the time segment B it is equal to the second frequency value f22=f21+Δf. The change of frequency from frequency value f21 to frequency value f22 happens at the moment in time t21 and the change of frequency from frequency value f22 back to the frequency value f21 at the moment in time t24, i.e. synchronously to the pulses of the second evaluation signal D2.

The change of frequency does change the amount of the distance of coincidence tm, merely the direction of the offset between the evaluation signals D1, D2, i.e. the sign of the phase difference between these signals changes. Therefore, when changing from the first frequency value f21 to the second frequency value f22, the pulse distance between the pulses of the first evaluation signal D1 is one-time reduced from value Td to value U=2tm=4 τ na and when changing back to the first frequency value f21 is one-time increased to value d=2Td-U. The change, resulting from frequency keying, of the pulse distance between the pulses of the first evaluation signal D1 thus dependents on the signal running time τ. Measuring the pulse distances between the pulses of the first evaluation signal D1 permits to determine the values U or D and to determine from it the signal running time τ and the distance between the transmitting and receiving stations 1, 2.

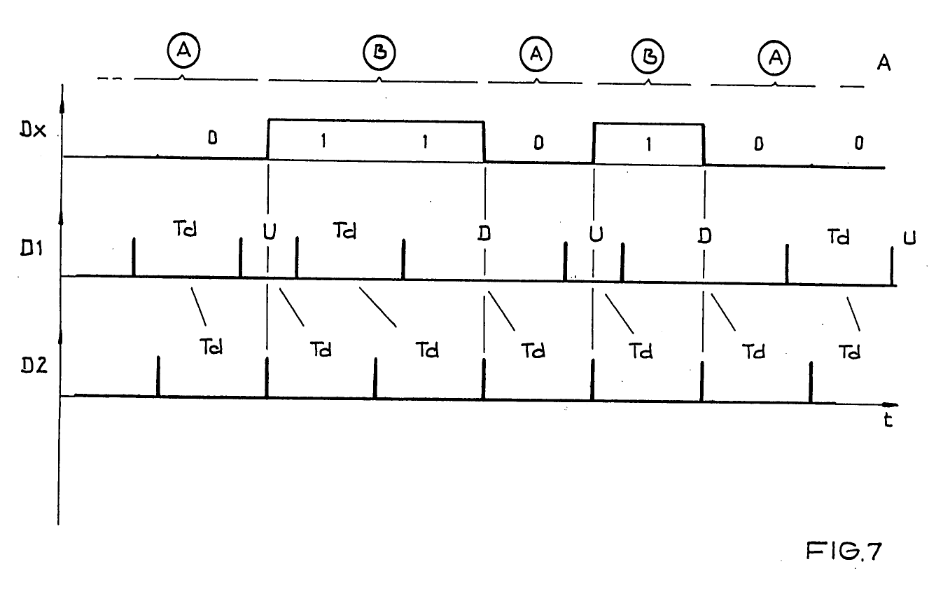

This type of frequency keying is particularly suitable for the serial transfer of digital data. Merely one of the logical values “0” or “1” is to be allocated to the frequency values f21, f22 as is shown in FIG. 7.

According to FIG. 7 a digital data signal Dx is transmitted from the second transmitting and receiving station 2 to the first transmitting and receiving station 1, by setting the pulse repetition frequency fp2 of the second transmission signal S2 in time segments A, in which a logical value “0” is to be transferred, onto the first frequency value f21 and in time segments B, in which a logical value “1” is to be transferred, onto the second frequency value F22. In the first transmitting and receiving station 1 based on the pulse distance between the pulses of the first evaluation signal D1 it is recognized whether a bit value in the data signal Dx has changed. If the pulse distance shortens to a value U being below the period Td, this is an indication of a bit value change from “0” to “1”, whereas this is an indication of a bit value change from “1” to “0”, if the pulse distance extends to a value D being above the period Td. In like manner also the first transmission signal S1 can be modulated by frequency keying, ensuring a bi-directional data transfer between the transmitting and receiving stations 1, 2.

Based on the periodicity of the transmission signals S1, S2 the described methods provide clear results of measurement merely for signal running times τ, which are within a region of unambiguousness determined by the pulse repetition frequencies fp1, fp2. Indeed, the region of unambiguousness can be increased by changing the pulse repetition frequencies fp1, fp2, for example by frequency division, however, this involves a reduction of the measurement resolution.

Exceeding the region of unambiguousness during a measurement can be recognized by means of an additional measurement, by increasing the region of unambiguousness for the additional measurement by changing the pulse repetition frequencies fp1, fp2 and by testing whether the result of the additional measurement is within the region of unambiguousness of the one measurement.

1. A method for determining the distance between a first and second transmitting and receiving station (1, 2), characterized in that
in the first and second transmitting and receiving station (1, 2) a first and second transmission signal (S1, S2) is generated and is transmitted as a series of microwave pulses having a predefined pulse repetition frequency (fp1, fp2) to the respective other transmitting and receiving station (2, 1) and is received thereby in the form of a received signal (E2, E1), said pulse repetition frequencies (fp1, fp2) of the transmission signals (S1, S2) varying according to a predefined differential frequency value (fd),
in the first and second transmitting and receiving station (1, 2) first and second points of coincidence (t11, t12, . . . ; t21, t22, . . . ) are determined, which correspond to those moments in time, when the pulses of the transmission signal (S1, S2) sent by the respective transmitting and receiving station (1, 2) and the received signal (E1, E2) received by the respective transmitting and receiving station (1, 2) coincide,
the distance between the transmitting and receiving stations (1, 2) is determined from the distances (tm; x, y; U, D) between the points of coincidence.

2. A method according to claim 1, characterized in that a distance of coincidence (tm) corresponding to the time offset between the first and second points of coincidence is determined as a measure of the distance between the two transmitting and receiving stations (1, 2).

3. A method according to claim 2, characterized in that information on the second points of coincidence (t21, t22) is transmitted via a radio channel from the second transmitting and receiving station (2) to the first transmitting and receiving station (1) and in that the distance of coincidence (tm) is determined in the first transmitting and receiving station (1) from the transmitted information and from the first points of coincidence (t11, t12) determined in the first transmitting and receiving station (1).

4. A method according to claim 3, characterized in that the transmission of the information on the second points of coincidence (t21, t22) and the transmission of the transmission signals (S1, S2) is performed via different radio channels.

5. A method according to claim 1, characterized in that the second transmission signal (S2) is modulated by frequency keying of its pulse repetition frequency (fp2) and that a change (td), resulting from frequency keying, of the distance (Td) between the first points of coincidence (t11, t12, . . . ) is determined as a measure of the distance between the transmitting and receiving stations (1, 2).

6. A method according to claim 5, characterized in that the pulse repetition frequency (fp2) of the second transmission signal (S2) is switched at frequency keying between two fixed frequency values (f21, f22), the switch being performed synchronously to the second points of coincidence (t21, t22, . . . ).

7. A method according to claim 6, characterized in that the two fixed frequency values (f21, f22) are specified such that the change from one frequency value (f21) to the other frequency value (f22) causes duplication of the amount of the difference between the pulse repetition frequencies (fp1, fp2) of the transmission signals (S1, S2).

8. A method according to claim 6, characterized in that the two fixed frequency values (f21, f22) are specified such that the change from one frequency value (f21) to the other frequency value (f22) causes a reverse counting of the difference between the pulse repetition frequencies (fp1, fp2) of the transmission signals (S1, S2).

9-12. (canceled)

13. A method according to claim 1, characterized in that the differential frequency value (fd) is substantially smaller than the pulse repetition frequencies (fp1, fp2).

14. A method according to claim 1, characterized in that the two transmission signals (S1, S2) are modulated for the transfer of data.

15. A method according to claim 1, characterized in that in the transmitting and receiving stations (1, 2) the transmission signal (S1, S2) generated in the respective transmitting and receiving station (1, 2) is converted with the received signal (E1, E2) received by this station by mixing into an intermediate frequency signal (Z1, Z2), that the intermediate frequency signal (Z1, Z2) is converted into a pulsed evaluation signal (D1, D2) by filtering and envelope demodulation and that the temporal position of the pulses of the evaluation signal (D1, D2) is determined as points of coincidence (t11, t12, t21, t22).

16. Use of the method according to claim 1, in a keyless locking system for motor vehicles for determining the distance between a first transmitting and receiving station provided in the motor vehicle and a second transmitting and receiving station provided in a key module.
